(19) United States
(12) Patent Application Publication
(10) Pub. No.: US 2008/0298399 A1
(43) Pub. Date: Dec. 4, 2008

(54) Methods for Synchronizing the Transmission and the Reception of a Media Stream Over a Network

(75) Inventors: Dayin Gou, San Jose, CA (US); Chung-Ping Wu, San Jose, CA (US); Jiankun Li, Newark, CA (US)

Correspondence Address: Venture Pacific Law, PC, 5201 Great America Parkway, Suite 270, Santa Clara, CA, 95054, US

(73) Assignee: AUGUSTA TECHNOLOGY, INC., Santa Clara, CA (US)

(21) Appl. No.: 12/121,732

(22) Filed: May 15, 2008

Related U.S. Application Data
(60) Provisional application No. 60/941,638, filed on Jun. 1, 2007.

(51) Int. Cl. H04J 3/06

(52) U.S. Cl. 370/503

(57) ABSTRACT

The present invention relates to methods for synchronizing the transmission and the reception of a media stream over a network, such as the Internet, comprising of a receiver clock having an adjustable reset value, where the adjustable reset value may be a function of the reference time for a receiver clock and the reference time for a sender clock.

### CROSS REFERENCE

This application claims priority from a provisional patent application entitled “Methods for Synchronizing Clocks for Media Transmission and Receiving” filed on Jun. 1, 2007 and having an Application No. 60/941,638. Said application is incorporated herein by reference.

### FIELD OF INVENTION

This invention relates to methods for synchronizing the transmission and the reception of a media stream over a network, such as the Internet, and, in particular to, methods for synchronizing a receiver clock during the reception of a media stream with the sender clock during the transmission of the media stream.

### BACKGROUND

In media broadcasting and streaming applications, a sender transmits media to a receiver over a network, such as, but not limited to, the Internet. For instance, a sender may transmit audio-visual media to a receiver over the Internet. The video content and the audio content can be decoded on the receiver side, in which the video pixel data of the video content is sent to a video digital-to-analog converter (“DAC”) and the audio pulse-code modulation (“PCM”) samples of the audio content are sent to an audio DAC to be rendered for output. Two technical issues have to be resolved in the scheduling of the output of the video content and of the audio content. The first issue is the synchronization between the receiver and the sender, and the second issue is the synchronization between the audio content and the video content.

Here, the synchronization between a sender and a receiver refers to the synchronization of the clock used on the receiver side to output or render media with the clock used on the sender side to send the media. For simplicity, the clock used on the receiver side is referred to as the receiver clock, and the clock used on the sender side is referred to as the sender clock.

Media can be audio content, video content, or any other kind of data carrying information. The term “stream” or “media stream” will be used to mean audio content stream, video content stream, or other kind of data stream depending on the context.

The synchronization between a sender and a receiver is necessary to avoid buffer overflow or buffer underflow, either of which may result in an undesirable audio-visual experience for a viewer of the media stream. For instance, in the reception of an audio-visual media stream, the audio content of the media may suddenly go mute during playback due to an audio content underflow, while non-smooth video jumps or transitions may occur during the display of the video content due to a video buffer overflow.

The synchronization between the audio content and the video content, also referred to as lip sync, is vital for a pleasant audio-visual experience. For example, if the audio content of an audio-visual media stream is not synchronized with the video content of the audio-visual media stream, then what a viewer hears as speech may not correspond to what the viewer sees as the motion of the mouth articulating the speech, and thus it may be disconcerting or irritating to the viewer. Audio content and video content synchronization may be implemented by matching or synchronizing the video output with the audio output. For instance, an audio output may drive the pace of an audio-visual media, while the video output of the audio-visual media is synchronized to follow the audio output.

The synchronization of a receiver clock and a sender clock can be conducted by measuring the corresponding time interval difference between the receiver clock and the sender clock, then adjusting the receiver clock to reduce the difference. Once this is accomplished, the synchronization of the audio content and the video content at the receiver side may be achieved using the timing relationship that is expressed as timestamps carried in the audio-visual media stream.

Therefore, it is desirable to provide methods for synchronizing the receiver clock and the sender clock in the transmission and reception of a media broadcast or stream over a network.

### SUMMARY OF INVENTION

An object of this invention is to provide methods for synchronizing a receiver clock with a sender clock.

Another object of this invention is to provide methods for generating smooth audio decompressed data output and provide the basic foundation for audio and video synchronization for media playback on the receiver side.

The present invention relates to methods for synchronizing the transmission and the reception of a media stream over a network, such as the Internet, comprising of a receiver clock having an adjustable reset value, where the adjustable reset value may be a function of the reference time for a receiver clock and the reference time for a sender clock.

An advantage of this invention is that the methods of the present invention may reduce buffer underflow and buffer overflow in the broadcasting or streaming of media over a network.

Another advantage of this invention is that the methods of the present invention may generate smoother audio decompressed data output.

Yet another advantage of this invention is that minimal hardware components are needed for the regulation or adjustment of the receiver clock.

### DESCRIPTION OF THE DRAWINGS

The foregoing and other objects, aspects, and advantages of the invention will be better understood from the following detailed description of the preferred embodiments of the invention when taken in conjunction with the accompanying drawings in which:

FIG. 1 illustrates one embodiment of the present invention of a system that synchronizes the reception of a media stream with the transmission of the media stream.

FIGS. 2a and 2b are the process flow for a preferred embodiment of the methods of this invention.

### DETAILED DESCRIPTION OF THE PREFERRED EMBODIMENTS

The presently preferred embodiments of the present invention provide methods for synchronizing the transmission and the reception of a media stream over a network, such as the Internet, and, in particular to, methods for synchronizing the receiver clock during the reception of a media stream with the sender clock.

Despite different encapsulation schemes that may be used in different standards, such as Digital Video Broadcasting-Handheld (“DVB-H”), Terrestrial Digital Multimedia Broadcasting (“TDMB”), Digital Video Broadcasting-Terrestrial (“DVB-T”), Digital Video Broadcasting-Cable (“DVB-C”), Real-time Transport Protocol (“RTP”), etc., timestamps are usually periodically embedded in the media stream sent by the sender to the receiver to indicate the reproduction time corresponding to a bit location in the media stream.

The transmission time on the sender side, which may be indicated by the timestamp, will be referred to herein as the nth reference time on the sender side, tᵣ(n). The time measured at the receiver clock at the nth reference time may be denoted as tₐ(n), and herein referenced as the nth reference time on the receiver side. An example of a receiver clock that is used in the methods of this invention is a down counter that is described herein. Since the sender clock of a media stream may operate at a different timing speed than the receiver clock of the media stream, the receiver clock may need to be synchronized with the sender clock. This can be done by periodically adjusting the receiver clock to match the speed of the sender clock to prevent buffer overflow or underflow.

The following terminology is used to aid in the understanding of the methods of this invention.

The reference time, tᵣ(n), is the nth reference time on the sender side. In the preferred embodiments, the reference time, tᵣ(n), may be the time of the nth timestamp.

The locally measured time, tₐ(n), is the time measured on the receiver clock corresponding to the nth reference time of the sender, tᵣ(n). The locally measured time is a snapshot of the receiver clock when a reference time, tᵣ(n), is detected.

The time interval at the sender side, dᵣ(n), also referred to herein as the sender time interval, may mean the time between two reference time points on the sender side at the nth reference time, Equation (1). The time interval, dᵣ(n), uses the time notion of the sender side and can be described by the following equation:

dᵣ(n)=tᵣ(n)−tᵣ(n−1) (1)

The time interval on the receiver side, dₐ(n), corresponding to the nth reference time, referred to herein as the receiver time interval, may mean the time interval on the receiver side corresponding to the time interval dᵣ(n) on the sender side, Equation (1). The time interval, dₐ(n), uses the time notion of the receiver clock and can be described by the following equation:

dₐ(n)=tₐ(n)−tₐ(n−1) (2)

The short term time difference, sₑ(n), is a measure for synchronization at the nth reference time. It is the difference between the receiver time interval and the sender time interval, Equation (3).

sₑ(n)=dₐ(n)−dᵣ(n) (3)

The long term time difference at the nth reference time, lₑ(n), is the accumulated time difference, and is a second measure for synchronization. Equation (4) expresses this mathematical relationship. The time of the first arrival of the reference time, le(0), can be initialized to 0 since there is no long term time difference at the 0^{th} reference time.

lₑ(n)=lₑ(n−1)+sₑ(n) (4)

A down counter may be a device that repeatedly counts down from a reset value to zero. The down counter may be adjustable if the reset value is adjustable. The period of the adjustable down counter at the nth reference time, p(n), can be the clock cycle(s) that it takes at the nth reference time for the down counter to count down from its reset value to zero.

The receiver usually has a main clock that is used to drive the embedded processors or other hardwired logic to process received audio content, video content, and other content. The frequency of this main clock is usually much higher than the receiver clock, where the receiver clock is used to output media. For example, if the media is audio content, the main clock may be running at 200 MHz, while the typical audio sampling frequency is 48 KHz, a ratio of about 200M/48K=4167. This large difference between the frequency of the main clock and the receiver clock allows for fine adjustment of the receiver clock, so as to synchronize the time notion on the receiver side with the time notion on the sender side.

One preferred embodiment of this invention provides methods for synchronizing the sender clock and the receiver clock to avoid buffer overflow or underflow by utilizing a down counter with an adjustable reset value. This down counter may be driven by the main clock and designed such that it can output an impulse to trigger media output when the down counter reaches zero.

The impulse sent by the down counter can be used to trigger the media data output, for example, audio PCM data output. In the preferred embodiments of this invention, the adjustable down counter is used to drive the receiver clock. The timing to output media can be adjusted by changing the period of the reset value of the down counter. The period of this down counter can be adjusted and fine-tuned in an amount that may be based on a measure of synchronization, such as the short term time difference on the receiver side, se. Thus, if the duration between impulses generated by the down counter is too long, the time period of the down counter can be decreased toward the desired value.

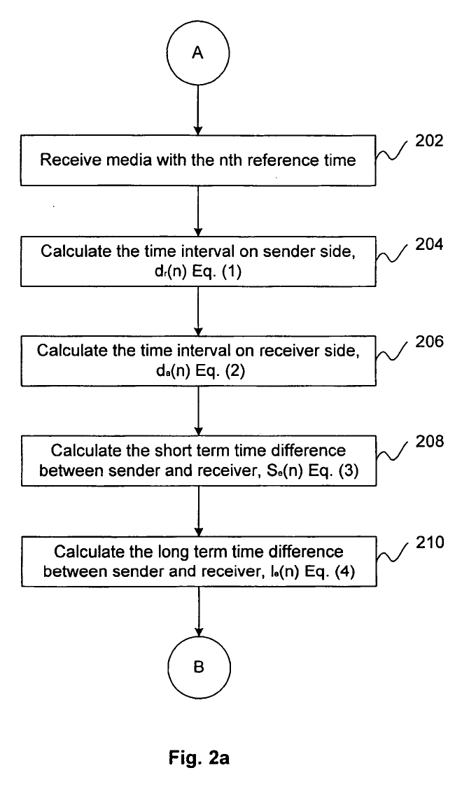

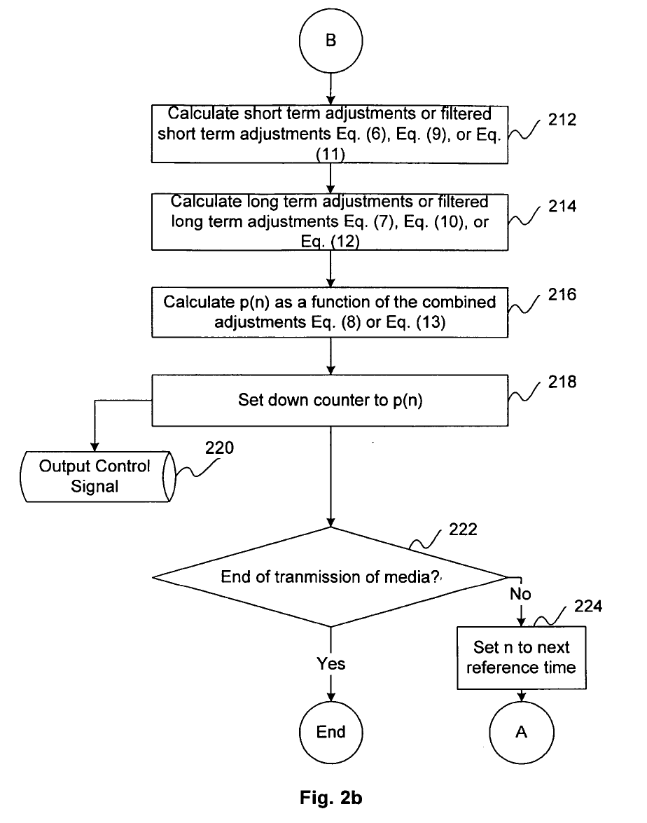

The preferred embodiments of this invention provide for methods for accomplishing this by adjusting the time period of the down counter by the following steps. FIGS. 2a and 2b will be referred herein to aid in the understanding of the methods of this preferred embodiment.

First, the sender side transmits media over a network to the receiver side. The network may be defined as, but not limited to, a computer network, such as the Internet, a telecommunications network, a cellular phone network, a telephone network, or other network where media may be transmitted. Timestamps may be embedded in the media transmission, such that the timestamps may be used to find the nth reference time. Said timestamps may mean a sequence of characters, denoting the date and/or time at which a certain event occurred. The receiver side receives the media with the initial timestamp, corresponding to the nth reference time, 202.

The initial value of the period of the down counter, p(0), may be set to a predefined initial value. This initial value may be defined to be the quotient of the main clock frequency, fₘ, divided by the expected media data output frequency, fₐ, Equation (5).

p(0)=fₘ/fₐ. (5)

For example, p(0) may be defined to be 4167 for a 48 KHz audio PCM data output with fₘ equaled to 200 MHz.

Next, for the nth reference time, the time interval on sender side 204, dᵣ(n), is calculated by using Equation (1). The time interval on the receiver side 206, dₐ(n), is calculated by using Equation (2). The time interval at the sender side, dᵣ(n), is compared with the corresponding interval at the receiver side, dₐ(n). If those two time intervals are equal, i.e. dᵣ(n)=dₐ(n), then no adjustment of the time notion on the receiver side is needed. However, the time notions of the sender side and receiver side are usually different because the receiver clock rarely can lock its time notion exactly to that of the reference. Therefore, usually dᵣ(n) and dₐ(n) are not equal.

One or more measures of synchronization between the sender and the receiver are selected. In the preferred embodiments, two measures, the short term time difference 208, sₑ(n), and the long term time difference 210, lₑ(n), are calculated using Equation (3) and Equation (4), respectively. Ideally, for perfect synchronization, the value of these two measures should be approximately equal. For example, if sₑ(n) and lₑ(n) are the measures chosen, then there is perfect synchronization when the value of both are adjusted to zero.

The receiver clock is adjusted such that the value of these measures, sₑ(n) and lₑ(n), move toward perfect synchronization. Since perfect synchronization may not be possible more often than not, a preferred objective is to adjust the measures such that they will not diverge from their perfect synchronization values. The receiver clock can be adjusted by adjusting the reset value for the down counter, p(n). For example, when the short term time difference, sₑ(n), is positive, the receiver time interval, dₐ(n), is greater than the reference time interval on the sender side. This suggests that the period, p(n), is too small and needs to be increased. Different adjustments 212, as a function of the measures, can be used to adjust the period. One preferred embodiment of the methods of this invention is to select two adjustments 214, when sₑ(n) and lₑ(n) are used as measures to adjust the period p(n) at the nth reference time. The first adjustment is a function of the short term time difference, dₚₛ(n), which is expressed in Equation (6). And the second adjustment is a function of the long term time difference, dₚₛ(n), which is expressed in Equation (7). Note that dₚₗ(n) can be made proportional to the long term time difference, while dₚₛ(n) can be made proportional to the short term time difference. The adjustment to the period may be the sum of the long term adjustments and the short term adjustments. Equation (8).

dₚₛ(n)=kₛ*sₑ(n) (6)

dₚₗ(n)=kₗ*lₑ(n) (7)

p(n)=p(n−1)+dₚₛ(n)+dₚₗ(n) (8)

Adjustment to the period p(n), also referred to herein as the regulation of the period, can be made by using Equation (8) to calculate p(n) 216 as a function of the selected adjustments at each arrival of the reference time. The down counter is then set to p(n) 218, where p(n) 220 is also outputted for later use. If the media transmission has ended 222, then synchronization of the receiver clock is finished. However, if media is still being received on the receiver side, then the receiver side sets n 224 to the next reference time, n+1, of the media and restarts the calculation by receiving media with the next reference time 202. The goal of calculating p(n) at each arrival of the reference time is for the measures to converge to a pre-determined value indicating synchronization. For instance, if the measures are Sₑ(n) and le(n), then the goals of these repeated adjustments are for these two measures to both converge toward zero.

The constants, kₛ of Equation (6) and kₗ of Equation (7), are parameters used to control the amount of adjustment. They can be determined by simulation or online experiment. While larger values for these constants may allow for faster convergence, the steady state errors also become accordingly larger. In addition, values for the constants that are too large may cause the adjustment to be unstable, and even oscillate. Therefore, the chosen value for these parameters can be based on a trade-off between a faster convergence and a smaller steady state error.

Equations (5) through (7) are based on a linear relationship between adjustments and the short term and long term time differences, respectively. Other embodiments of the methods of this invention may use different adjustments as well as different functional relationships between the adjustments and their synchronization measures.

Except for the first arrival of reference time, where only tᵣ(0) and tₐ(0) need to be stored, for each successive arrival of the reference time, Equations (1) through (7) may be used to adjust or regulate the receiver clock. This regulation can be implemented either by hardware or by software.

Whether the regulation is conducted with software or with hardware, the following components may be needed, comprising: a down counter driven directly or indirectly by the main clock or some other free-running clock; a register both readable and writeable to hold the period value of the down counter; a register to indicate the time measured by the receiver clock, which may be updated every time the down counter counts to zero; and a generated output signal or impulse to trigger the media data output, for example, an impulse used to drive an audio DAC.

There are two methods to take snapshots of audio time, depending on whether the low-level hardware can detect the bit location of the reference time or not. If the low-level hardware can detect the bit location, it can send a triggering signal to latch the time on the receiver clock. If the low level hardware cannot detect the bit location, the embedded software may be used to take a snapshot of the audio time for each time the software detects the bit location. The software processing may incur some non-determinism for timing, which may be caused by context switching between different software tasks or variable delays caused by bus arbitration. This non-determinism for timing in the software processing can be referred to as high jitter mode. Low jitter mode will be herein referred to for the hardware triggered latching since there is negligible jitter, if any, in the hardware triggered latching.

In low jitter mode, the synchronization measures that are used for adjustment, such as sₑ(n) and lₑ(n), are not substantially affected by the jitter. Here, the regulation or adjustment may be implemented by using Equations (1) through (8), as described earlier.

In high jitter mode, the synchronization measures that are used may be contaminated by the jitter unless they are processed to mitigate the jitter effect. If there is too much jitter, the short term time difference and the long term time difference as described by Equations (3) and (4) cannot be used directly. Low pass filtering on these measures to filter out the high jitter may be used to obtain filtered synchronization measures. The filtered measure can provide information on the degree of synchronization and be the basis for the regulation or adjustment of the receiver clock. In high jitter mode, the filtered short term time difference will be referred to as fsₑ(n); the filtering function for sₑ(n) will be referred to as lpfs(sₑ, n); the filtered long term time difference will be referred to as flₑ(n); the filtering function for le(n) will be referred to as lpfl(lₑ,n). The two measures that can be used are:

fsₑ(n)=lpfs(sₑ,n) (9)

flₑ(n)=lpfl(lₑ,n) (10)

The equations governing the adjustment using fsₑ(n) and flₑ(n) as synchronization measures are:

fdₚₛ(n)=fkₛ*fsₑ(n) (11)

fdₚₗ(n)=fkₗ*flₑ(n) (12)

p(n)=p(n−1)+fdₚₛ(n)+fdₚₗ(n) (13)

where fdₚₛ(n) is the adjustment based on the filtered short term time difference, fdₚₗ(n) is the adjustment based on the filtered long term time difference, and the parameters fkₛ and fkₗ are parameters used to control the amount of adjustments. Thus, in high jitter mode, the regulation can be implemented by using Equations (1) through (4) and Equations (9) through (13).

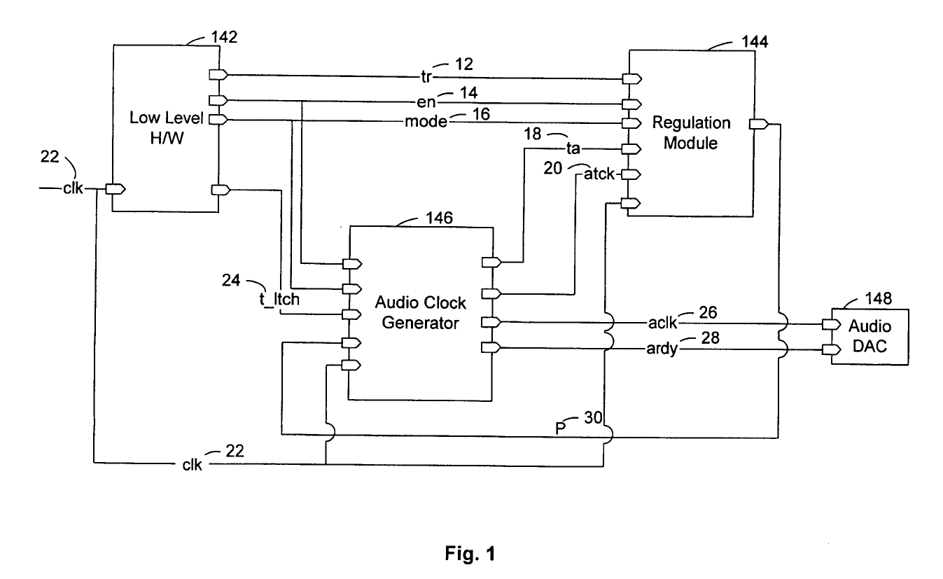

FIG. 1 is an embodiment of the methods of this invention. Here, the audio clock generator 146 is used as an example of a receiver clock and the audio DAC 148 is used as an example of a media output device. The audio clock generator 146 may be adjusted with a down counter with associated registers as described herein. The low-level hardware module 142 may be used to store the time measured on the audio clock generator 146 at each arrival of reference time. The regulation module 144 implements the regulation processing by calculating the adjusted period 30, P, then outputting the period value to the audio clock generator 146. The regulation module can be a hardware device or a software program.

The audio clock generator 146 is connected to the audio DAC 148, a piece of hardware that is used to render the audio decompressed data in to an audio sound. The audio clock generator 146, the low-level hardware module 142, and a regulation module 144 are connected, either physically or through software, to each other with the following signals or information, indicated by arrows in FIG. 1. The “en” signal 14 indicates to the audio clock generator 146 and to the regulation module 144 whether the low-level hardware 142 is booting or already up and running. The “mode” signal 16 indicates to the audio clock generator 146 and to the regulation module 144 whether the low level hardware 142 will trigger audio time latching (low jitter) or not (high jitter). The “t_ltch” signal 24 is used to trigger the audio time latching in the audio clock generator 146. The “tᵣ” signal 12 is the reference time sent from the low level hardware 142 to the regulation module 144. The “tₐ” signal 18 is the audio time that is latched inside the audio clock generator 146 and sent from the audio clock generator 146 to the regulation module 144. The “atck” signal 20 is the audio time manifested on the audio clock in the audio clock generator. The “atck” signal 20 is used to internally latch tₐ in low jitter mode. It may also be used by the regulation module 144 to take snapshots of the audio time in high jitter mode. The “aclk” signal 26 is the audio output pulse generated by the audio clock generator 146 to drive the audio DAC 148. The “ardy” signal 28 indicates whether the audio clock generator 146 is ready, up, and running. And the “clk” signal 22 is from a free-running local clock on the receiver side, usually it is the main clock used in the digital logic or by the embedded processor.

While the present invention has been described with reference to certain preferred embodiments, it is to be understood that the present invention is not limited to such specific embodiments. Rather, it is the inventor's contention that the invention be understood and construed in its broadest meaning as reflected by the following claims. Thus, these claims are to be understood as incorporating not only the preferred embodiments described herein but all those other and further alterations and modifications as would be apparent to those of ordinary skilled in the art.

We claim:

1. A method for synchronizing clocks between a sender and a receiver of media streams by using a receiver clock having a down counter wherein said media streams provide periodic timestamps and said down counter having an adjustable reset value, comprising the steps of:
calculating an adjustable reset value as a function of the timestamps from the received media stream and the time measured on the receiver clock; and
counting down from said reset value.

2. The method of claim 1 wherein in said calculating step, one or more long term time differences are used in the calculation of the reset value.

3. The method of claim 1 wherein in said calculating step, one or more short term time differences are used in the calculation of the reset value.

4. The method of claim 2 wherein in said calculating step, one or more short term time differences are used in the calculation of the reset value.

5. The method of claim 2 wherein the one or more long term time differences are filtered using a low pass filter, before being used in the calculation of the reset value.

6. The method of claim 3 wherein the one or more short term time differences are filtered using a low pass filter, before being used in the calculation of the reset value.

7. The method of claim 4 wherein the one or more long term time differences are filtered using a low pass filter, before being used in the calculation of the reset value.

8. The method of claim 7 wherein the one or more short term time differences are filtered using a low pass filter, before being used in the calculation of the reset value.

9. The method of claim 4 wherein the one or more short term time differences are filtered using a low pass filter, before being used in the calculation of the reset value.

10. A method for synchronizing clocks between a sender and a receiver of media streams by using a receiver clock having a down counter wherein said media streams provide periodic timestamps and said down counter having an adjustable reset value, comprising the steps of:
calculating an adjustable reset value as a function of the timestamps from the received media stream and the time measured on the receiver clock, wherein one or more long term time differences and one or more short term time differences are used in the calculation of the reset value; and
counting down from said reset value.

11. The method of claim 10 wherein the one or more long term time differences are filtered using a low pass filter, before being used in the calculation of the reset value.

12. The method of claim 10 wherein the one or more short term time differences are filtered using a low pass filter, before being used in the calculation of the reset value.

13. The method of claim 12 wherein the one or more long term time differences are filtered using a low pass filter, before being used in the calculation of the reset value.

14. A method for synchronizing clocks between a sender and a receiver of media streams by using a receiver clock having a down counter wherein said media streams provide periodic timestamps and said down counter having an adjustable reset value, comprising the steps of:
calculating an adjustable reset value as a function of the timestamps from the received media stream and the time measured on the receiver clock, wherein one or more long term time differences and one or more short term time differences are used in the calculation of the reset value; wherein the one or more long term time differences are filtered using a low pass filter, before being used in the calculation of the reset value; and wherein the one or more short term time differences are filtered using a low pass filter, before being used in the calculation of the reset value; and
counting down from said reset value.
